(19) United States
(12) Patent Application Publication
(10) Pub. No.: US 2014/0354605 A1
(43) Pub. Date: Dec. 4, 2014

(54) ELECTRONIC DEVICE AND HANDWRITING INPUT METHOD

(71) Applicant: Kabushiki Kaisha Toshiba, Tokyo (JP)

(72) Inventor: Yukihiro Kurita, Kokubunji-shi (JP)

(73) Assignee: Kabushiki Kaisha Toshiba, Tokyo (JP)

(21) Appl. No.: 14/257,497

(22) Filed: Apr. 21, 2014

Related U.S. Application Data
(63) Continuation of application No. PCT/JP2013/065101, filed on May 30, 2013.

(51) Int. Cl. G06F 3/0354

(52) U.S. Cl. CPC G06F 3/03545
USPC 345/179

(57) ABSTRACT

According to one embodiment, in a first mode, an electronic device displays a handwritten stroke on a screen, based on events which are input from a first sensor in accordance with a movement of a first object on the screen, and executes a first process corresponding to a gesture operation of a second object on the screen, based on events which are input from a second sensor in accordance with a movement of the second object on the screen. In a second mode, the device displays a handwritten stroke on the screen, based on events which are input from the second sensor in accordance with a movement of the second object on the screen. The device switches the input mode to the first mode, in response to a first event from the first sensor in the second mode.

### CROSS-REFERENCE TO RELATED APPLICATIONS

This application is a Continuation Application of PCT Application No. PCT/JP2013/065101, filed May 30, 2013, the entire contents of which are incorporated herein by reference.

### FIELD

Embodiments described herein relate generally to a technique of processing a handwritten document.

### BACKGROUND

In recent years, various kinds of electronic devices, such as a tablet, a PDA and a smartphone, have been developed. Most of these electronic devices include touch-screen displays for facilitating input operations by users.

By touching a menu or an object, which is displayed on the touch-screen display, by a finger or the like, the user can instruct an electronic device to execute a function which is associated with the menu or object.

However, most of existing electronic devices with touch-screen displays are consumer products which are designed to enhance operability on various media data such as video and music, and are not necessarily suitable for use in a business situation such as a meeting, a business negotiation or product development. Thus, in business situations, paper-based pocket notebooks have still been widely used.

Recently, an electronic device, which has an input mode for inputting characters, etc. by a pen and an input mode for inputting characters, etc. by a touch of a finger or the like, has also been developed.

Conventionally, however, no consideration has been given to a technique for dynamically changing an operation which is executed in accordance with a touch of a finger, etc. on a screen.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic device according to an embodiment.

FIG. 2 is an exemplary view illustrating a cooperative operation between the electronic device of the embodiment and an external apparatus.

FIG. 3 is a view illustrating an example of a handwritten document which is handwritten on a touch-screen display of the electronic device of the embodiment.

FIG. 4 is an exemplary view for explaining time-series information corresponding to the handwritten document of FIG. 3, the time-series information being stored in a storage medium by the electronic device of the embodiment.

FIG. 5 is an exemplary block diagram illustrating a system configuration of the electronic device of the embodiment.

FIG. 6 is an exemplary view for describing a handwriting input process with use of a pen and a process corresponding to a finger gesture, which are executed by the electronic device of the embodiment.

FIG. 7 is an exemplary view for describing a handwriting input process which is executed by the electronic device of the embodiment in a touch input mode.

FIG. 8 is an exemplary view for describing an operation of automatically turning off the touch input mode, the operation being executed by the electronic device of the embodiment.

FIG. 9 is an exemplary flowchart for describing the procedure of a touch input mode release process which is executed by the electronic device of the embodiment.

FIG. 10 is an exemplary view illustrating a desktop screen which is displayed by the electronic device of the embodiment.

FIG. 11 is an exemplary view illustrating a setup screen which is displayed by the electronic device of the embodiment.

FIG. 12 is an exemplary view illustrating a note preview screen which is displayed by the electronic device of the embodiment.

FIG. 13 is an exemplary view illustrating a page edit screen which is displayed by the electronic device of the embodiment.

FIG. 14 is an exemplary view illustrating a page edit screen which is displayed by the electronic device of the embodiment in the touch input mode.

FIG. 15 is an exemplary view illustrating a search dialogue which is displayed by the electronic device of the embodiment.

FIG. 16 is an exemplary block diagram illustrating a functional configuration of a handwriting note application program which is executed by the electronic device of the embodiment.

FIG. 17 is an exemplary flowchart illustrating the procedure of a handwriting input process which is executed by the electronic device of the embodiment.

### DETAILED DESCRIPTION

Various embodiments will be described hereinafter with reference to the accompanying drawings.

In general, according to one embodiment, an electronic device includes a processor and a setup controller. If an input mode is a first mode, the processor is configured to display a handwritten stroke on a screen, based on an event which is input from a first sensor in accordance with a movement of a first object on the screen, and to execute a first process corresponding to a gesture operation of a second object on the screen, based on an event which is input from a second sensor in accordance with a movement of the second object on the screen, the second object different from the first object, the second sensor different from the first sensor. If the input mode is a second mode, the processor is configured to display a handwritten stroke on the screen, based on an event which is input from the second sensor in accordance with a movement of the second object on the screen. The setup controller is configured to set the input mode to be the first mode or the second mode in accordance with an operation of a user. The processor is configured to switch the input mode from the second mode to the first mode, in response to an input of a first event from the first sensor during a period in which the input mode is the second mode.

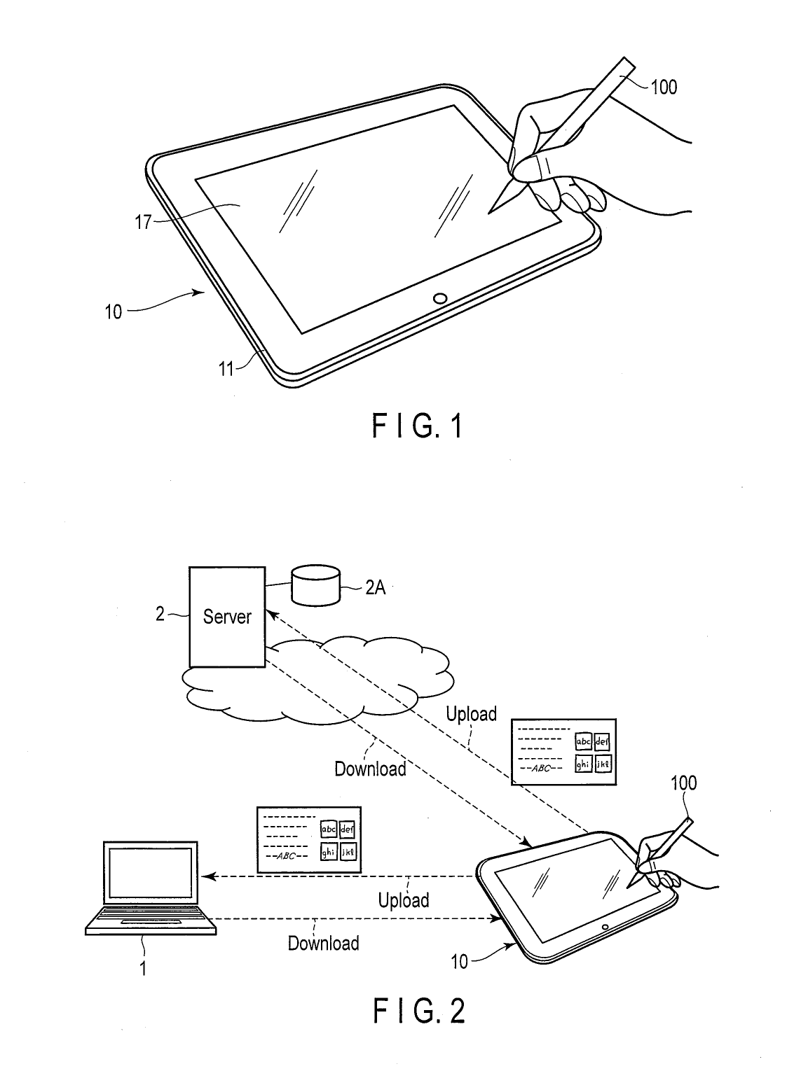

FIG. 1 is a perspective view illustrating an external appearance of an electronic device according to an embodiment. The electronic device is, for instance, a pen-based portable electronic device which can execute a handwriting input by a pen or a finger. This electronic device may be realized as a tablet computer, a notebook-type personal computer, a smartphone, a PDA, etc. In the description below, the case is assumed that this electronic device is realized as a tablet computer 10. The tablet computer 10 is a portable electronic device which is also called “tablet” or “slate computer”. As shown in FIG. 1, the tablet computer 10 includes a main body 11 and a touch-screen display 17. The touch-screen display 17 is attached such that the touch-screen display 17 is laid over the top surface of the main body 11.

The main body 11 has a thin box-shaped housing. In the touch-screen display 17, a flat-panel display and a sensor, which is configured to detect a touch position of a pen or a finger on the screen of the flat-panel display, are assembled. The flat-panel display may be, for instance, a liquid crystal display (LCD). As the sensor, for example, use may be made of an electrostatic capacitance-type touch panel, or an electromagnetic induction-type digitizer. In the description below, the case is assumed that two kinds of sensors, namely a digitizer and a touch panel, are both assembled in the touch-screen display 17.

The touch-screen display 17 can detect not only a touch operation on the screen with use of a finger, but also a touch operation on the screen with use of a pen 100. The pen 100 may be, for instance, a digitizer pen (electromagnetic-induction pen).

The user can execute a handwriting input operation on the touch-screen display 17 by using the pen 100 (pen input mode). During the handwriting input operation, a locus of movement of the pen 100 on the screen, that is, a stroke (a locus of a handwritten stroke) which is handwritten by a handwriting input operation, is drawn in real time, and thereby plural strokes, which have been input by handwriting, are displayed on the screen. A locus of movement of the pen 100 during a time in which the pen 100 is in contact with the screen corresponds to one stroke. A set of many strokes corresponding to handwritten characters, handwritten graphics or handwritten tables constitutes a handwritten document.

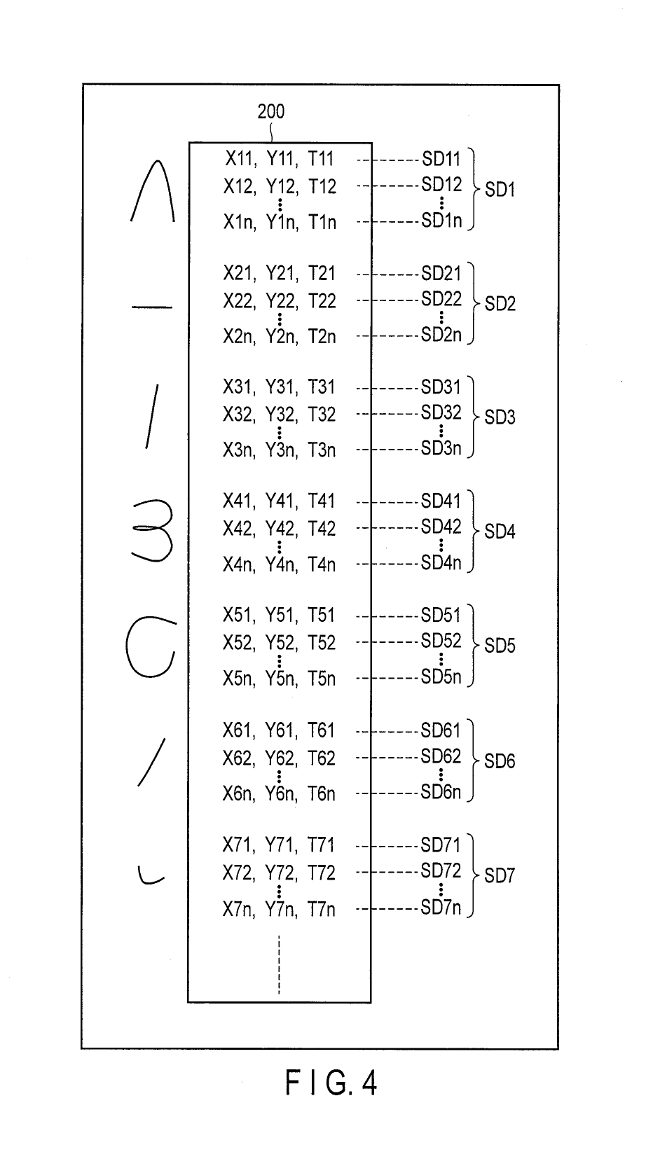

In the present embodiment, this handwritten document is stored in a storage medium not as image data but as time-series information (handwritten document data) indicative of coordinate series of the loci of strokes and the order relation between the strokes. The details of this time-series information will be described later with reference to FIG. 4. This time-series information indicates an order in which a plurality of strokes are handwritten, and includes a plurality of stroke data corresponding to a plurality of strokes. In other words, the time-series information means a set of time-series stroke data corresponding to a plurality of strokes. Each stroke data corresponds to one stroke, and includes coordinate data series (time-series coordinates) corresponding to points on the locus of this stroke. The order of arrangement of these stroke data corresponds to an order in which strokes were handwritten.

The tablet computer 10 can read out arbitrary existing time-series information from the storage medium, and can display on the screen a handwritten document corresponding to this time-series information, that is, a plurality of strokes indicated by this time-series information. A plurality of strokes indicated by the time-series information are also a plurality of strokes which are input by handwriting.

Furthermore, the tablet computer 10 of the embodiment includes a touch input mode which can execute a handwriting input operation by a finger, without using the pen 100. When the touch input mode is enabled, the user can execute a handwriting input operation on the touch-screen display 17 by using a finger. During the handwriting input operation, a locus of movement of the finger on the screen, that is, a stroke (a locus of a handwritten stroke) which is handwritten by a handwriting input operation, is drawn in real time. Thereby, a plurality of strokes, which have been input by handwriting, are displayed on the screen.

The touch input mode may be used as an input mode for temporarily enabling a handwriting input operation in accordance with the movement of a finger on the screen. Even when the user has forgotten the pen 100, the user can execute a handwriting input operation with a finger by enabling the touch input mode.

In addition, the tablet computer 10 has an edit function. The edit function can delete or move an arbitrary handwritten part (a handwritten character, a handwritten mark, a handwritten graphic, a handwritten table, etc.) in a displayed handwritten document, which is selected by a range select tool, in accordance with an edit operation by the user with use of an “eraser” tool, the range select tool, and other various tools. Besides, an arbitrary handwritten part in a handwritten document, which is selected by the range select tool, can be designated as a search key for searching for a handwritten document. Moreover, a recognition process, such as handwritten character recognition/handwritten graphic recognition/handwritten table recognition, can be executed on an arbitrary handwritten part in a handwritten document, which is selected by the range select tool.

In this embodiment, a handwritten document may be managed as one page or plural pages. In this case, the time-series information (handwritten document data) may be divided in units of an area which falls within one screen, and thereby a piece of time-series information, which falls within one screen, may be stored as one page. Alternatively, the size of one page may be made variable. In this case, since the size of a page can be increased to an area which is larger than the size of one screen, a handwritten document of an area larger than the size of the screen can be handled as one page. When one whole page cannot be displayed on the display at a time, this page may be reduced in size and displayed, or a display target part in the page may be moved by vertical and horizontal scroll.

FIG. 2 shows an example of a cooperative operation between the tablet computer 10 and an external apparatus. The tablet computer 10 can cooperate with a personal computer 1 or a cloud. Specifically, the tablet computer 10 includes a wireless communication device of, e.g. wireless LAN, and can wirelessly communicate with the personal computer 1. Further, the tablet computer 10 can communicate with a server 2 on the Internet. The server 2 may be a server which executes an online storage service, and other various cloud computing services.

The personal computer 1 includes a storage device such as a hard disk drive (HDD). The tablet computer 10 can transmit time-series information (handwritten document data) to the personal computer 1 over a network, and can store the time-series information (handwritten document data) in the HDD of the personal computer 1 (“upload”). In order to ensure a secure communication between the tablet computer 10 and personal computer 1, the personal computer 1 may authenticate the tablet computer 10 at a time of starting the communication. In this case, a dialog for prompting the user to input an ID or a password may be displayed on the screen of the tablet computer 10, or the ID of the tablet computer 10, for example, may be automatically transmitted from the tablet computer 10 to the personal computer 1.

Thereby, even when the capacity of the storage in the tablet computer 10 is small, the tablet computer 10 can handle many pieces of time-series information or large-volume time-series information.

In addition, the tablet computer 10 can read out (“download”) at least one piece of arbitrary time-series information stored in the HDD of the personal computer 1, and can display strokes indicated by the read-out time-series information on the screen of the display 17 of the tablet computer 10. In this case, the tablet computer 10 may display on the screen of the display 17 a list of thumbnails which are obtained by reducing in size pages of plural pieces of time-series information, or may display one page, which is selected from these thumbnails, on the screen of the display 17 in the normal size.

Furthermore, the destination of communication of the tablet computer 10 may be not the personal computer 1, but the server 2 on the cloud which provides storage services, etc., as described above. The tablet computer 10 can transmit time-series information (handwritten document data) to the server 2 over the network, and can store the time-series information in a storage device 2A of the server 2 (“upload”). Besides, the tablet computer 10 can read out arbitrary time-series information which is stored in the storage device 2A of the server 2 (“download”) and can display the loci of strokes indicated by the time-series information on the screen of the display 17 of the tablet computer 10.

As has been described above, in the present embodiment, the storage medium in which time-series information is stored may be the storage device in the tablet computer 10, the storage device in the personal computer 1, or the storage device in the server 2.

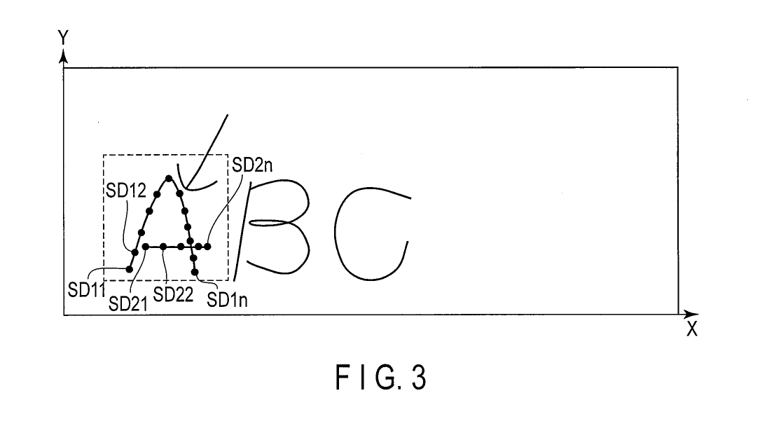

Next, referring to FIG. 3 and FIG. 4, a description is given of a relationship between strokes (characters, graphics, tables, etc.), which are handwritten by the user, and time-series information. FIG. 3 shows an example of a handwritten document (handwritten character string) which is handwritten on the touch-screen display 17 by using the pen 100 or the like.

In many cases, on a handwritten document, other characters or graphics are handwritten over already handwritten characters or graphics. In FIG. 3, the case is assumed that a handwritten character string “ABC” was handwritten in the order of “A”, “B” and “C”, and thereafter a handwritten arrow was handwritten near the handwritten character “A”.

The handwritten character “A” is expressed by two strokes (a locus of “ [symbol] ” shape, a locus of “-” shape) which are handwritten by using the pen 100 or the like, that is, by two loci. The locus of the pen 100 of the first handwritten “ [symbol] ” shape is sampled in real time, for example, at regular time intervals, and thereby time-series coordinates SD11, SD12, . . . , SD1n of the stroke of the “ [symbol] ” shape are obtained. Similarly, the locus of the pen 100 of the next handwritten “-” shape is sampled in real time, for example, at regular time intervals, and thereby time-series coordinates SD21, SD22, . . . , SD2n of the stroke of the “-” shape are obtained.

The handwritten character “B” is expressed by two strokes which are handwritten by using the pen 100 or the like, that is, by two loci. The handwritten character “C” is expressed by one stroke which is handwritten by using the pen 100 or the like, that is, by one locus. The handwritten “arrow” is expressed by two strokes which are handwritten by using the pen 100 or the like, that is, by two loci.

FIG. 4 illustrates time-series information 200 corresponding to the handwritten document of FIG. 3. The time-series information 200 includes a plurality of stroke data SD1, SD2, . . . , SD7. In the time-series information 200, the stroke data SD1, SD2, . . . , SD7 are arranged in time series in the order in which the strokes were handwritten.

In the time-series information 200, the first two stroke data SD1 and SD2 are indicative of two strokes of the handwritten character “A”. The third and fourth stroke data SD3 and SD4 are indicative of two strokes which constitute the handwritten character “B”. The fifth stroke data SD5 is indicative of one stroke which constitutes the handwritten character “C”. The sixth and seventh stroke data SD6 and SD7 are indicative of two strokes which constitute the handwritten “arrow”.

Each stroke data includes coordinate data series (time-series coordinates) corresponding to one stroke, that is, a plurality of coordinates corresponding to a plurality of points on the locus of one stroke. In each stroke data, the plural coordinates are arranged in time series in the order in which the stroke is written. For example, as regards handwritten character “A”, the stroke data SD1 includes coordinate data series (time-series coordinates) corresponding to the points on the locus of the stroke of the “ [symbol] ” shape of the handwritten character “A”, that is, an n-number of coordinate data SD11, SD12, . . . , SD1n. The stroke data SD2 includes coordinate data series corresponding to the points on the locus of the stroke of the “-” shape of the handwritten character “A”, that is, an n-number of coordinate data SD21, SD22, . . . , SD2n. Incidentally, the number of coordinate data may differ between respective stroke data.

Each coordinate data is indicative of an X coordinate and a Y coordinate, which correspond to one point in the associated locus. For example, the coordinate data SD11 is indicative of an X coordinate (X11) and a Y coordinate (Y11) of the starting point of the stroke of the “ [symbol] ” shape. The coordinate data SD1n is indicative of an X coordinate (X1n) and a Y coordinate (Y1n) of the end point of the stroke of the “ [symbol] ” shape.

Further, each coordinate data may include time stamp information T corresponding to a time point at which a point corresponding to this coordinate data was handwritten. The time point at which the point was handwritten may be either an absolute time (e.g. year/month/day/hour/minute/second) or a relative time with reference to a certain time point. For example, an absolute time (e.g. year/month/day/hour/minute/second) at which a stroke began to be handwritten may be added as time stamp information to each stroke data, and furthermore a relative time indicative of a difference from the absolute time may be added as time stamp information T to each coordinate data in the stroke data.

In this manner, by using the time-series information in which the time stamp information T is added to each coordinate data, the temporal relationship between strokes can be more precisely expressed.

Moreover, information (Z) indicative of a pen stroke pressure may be added to each coordinate data.

The time-series information 200 having the structure as described with reference to FIG. 4 can express not only the trace of handwriting of each stroke, but also the temporal relation between strokes. Thus, with the use of the time-series information 200, even if a distal end portion of the handwritten “arrow” is written over the handwritten character “A” or near the handwritten character “A”, as shown in FIG. 3, the handwritten character “A” and the distal end portion of the handwritten “arrow” can be treated as different characters or graphics.

Furthermore, in the present embodiment, as described above, handwritten document data is stored not as an image or a result of character recognition, but as the time-series information 200 which is composed of a set of time-series stroke data. Thus, handwritten characters can be handled, without depending on languages of the handwritten characters. Therefore, the structure of the time-series information 200 of the embodiment can be commonly used in various countries of the world where different languages are used.

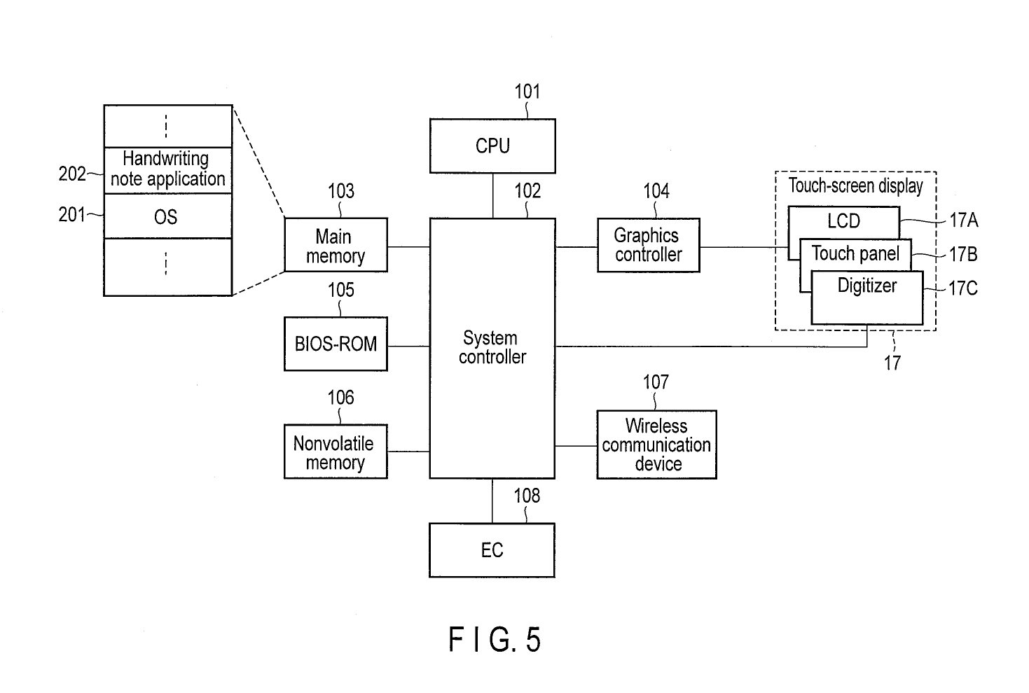

FIG. 5 shows a system configuration of the tablet computer 10.

As shown in FIG. 5, the tablet computer 10 includes a CPU 101, a system controller 102, a main memory 103, a graphics controller 104, a BIOS-ROM 105, a nonvolatile memory 106, a wireless communication device 107, and an embedded controller (EC) 108.

The CPU 101 is a processor which controls the operations of various modules in the tablet computer 10. The CPU 101 executes various kinds of software, which are loaded from the nonvolatile memory 106 that is a storage device into the main memory 103. The software includes an operating system (OS) 201 and various application programs. The application programs include a handwriting note application program 202. The handwriting note application program 202 includes a function of creating and displaying the above-described handwritten document data, a function of editing the handwritten document data, and a handwritten document search function for searching for handwritten document data including a desired handwritten part, or searching for a desired handwritten part in certain handwritten document data.

In addition, the CPU 101 executes a basic input/output system (BIOS) which is stored in the BIOS-ROM 105. The BIOS is a program for hardware control.

The system controller 102 is a device which connects a local bus of the CPU 101 and various components. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the tablet computer 10. A display signal, which is generated by the graphics controller 104, is sent to the LCD 17A. The LCD 17A displays a screen image based on the display signal. A touch panel 17B, LCD 17A and a digitizer 17C are laid over each other. The touch panel 17B is an electrostatic capacitance-type pointing device for executing an input on the screen of the LCD 17A. A contact position on the screen, which is touched by a finger, and a movement of the contact position are detected by the touch panel 17B. The digitizer 17C is an electromagnetic induction-type pointing device for executing an input on the screen of the LCD 17A. A contact position on the screen, which is touched by the pen (digitizer pen) 100, and a movement of the contact position are detected by the digitizer 17C.

The wireless communication device 107 is a device configured to execute wireless communication such as wireless LAN or 3G mobile communication. The EC 108 is a one-chip microcomputer including an embedded controller for power management. The EC 108 includes a function of powering on or powering off the tablet computer 10 in accordance with an operation of a power button by the user.

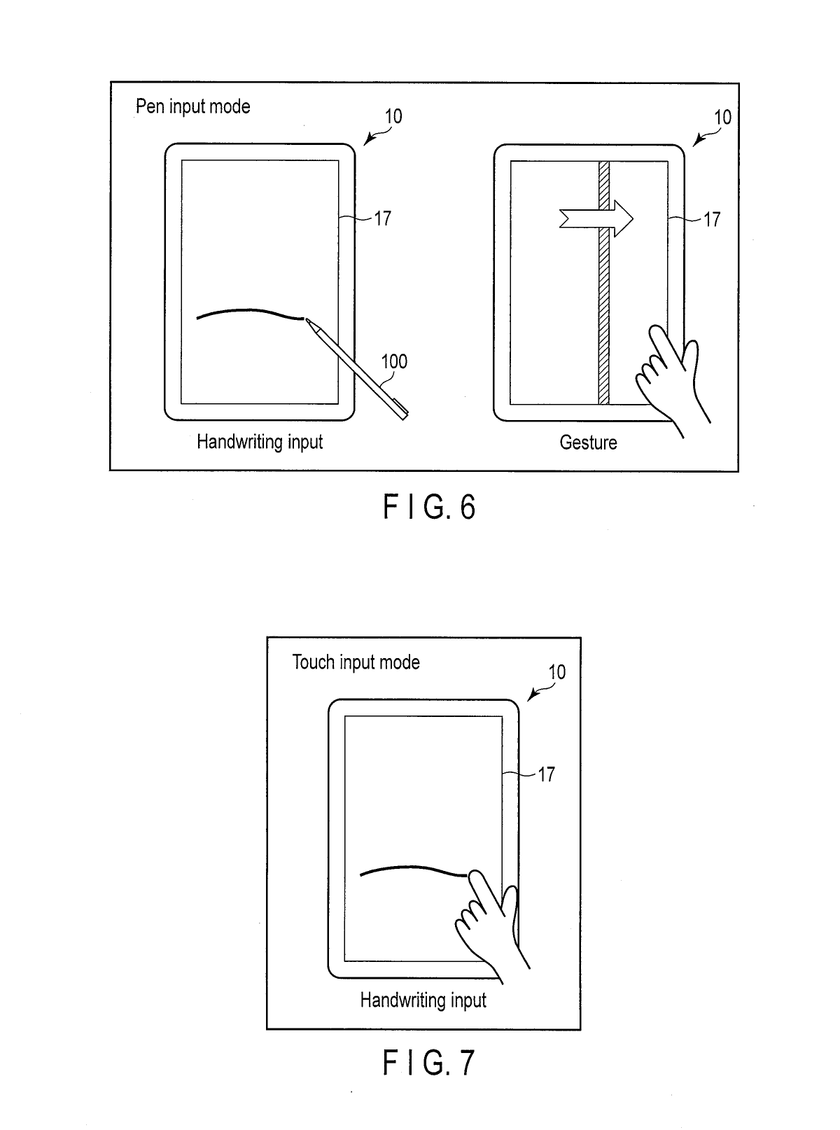

FIG. 6 illustrates a handwriting input process with use of the pen 100 and a process corresponding to a finger gesture, which are executed by the tablet computer 10.

The case is now assumed that almost the entire area of the screen of the touch-screen display 17 functions as a handwriting input area.

When the touch input mode is in an OFF state (disabled), or in other words, when the current input mode is a default input mode (pen input mode), the handwriting note application program 202 draws on the screen of the touch-screen display 17 a line (handwritten stroke) corresponding to the locus of movement of the pen 100 on the screen of the touch-screen display 17.

When the touch input mode is in the OFF state (disabled), the movement of a finger on the screen is not used for the drawing of a handwritten stroke. The movement of the finger on the screen is used for executing a process different from the drawing of a handwritten stroke.

When it has been detected that a movement of the finger on the screen corresponds to a certain gesture, the handwriting note application program 202 executes a process corresponding to the detected gesture. For example, when a swipe gesture by the finger has been detected, the handwriting note application program 202 executes a process of turning over a handwritten page (“page forward” or “page back”). When such a swipe gesture (right swipe gesture) that the contact position of the finger on the screen moves rightward has been detected, the handwriting note application program 202 executes a process of feeding the handwritten page to the next page. If the currently displayed handwritten page is the last page of a handwritten document (handwritten note), the handwriting note application program 202 may execute a process of adding a new page to the handwriting note. On the other hand, when such a swipe gesture (left swipe gesture) that the contact position of the finger on the screen moves leftward has been detected, the handwriting note application program 202 executes a process of turning the handwritten page back to the previous page.

In this manner, when the touch input mode is in the OFF state, that is, when the current handwriting input mode is the pen input mode, the handwriting note application program 202 uses events, which are input from the digitizer 17C, for a handwriting input process (display of handwritten strokes), and uses events, which are input from the touch panel 17B, for executing a process corresponding to a gesture (finger gesture).

In the handwriting input process, the handwriting note application program 202 can display a handwritten stroke on the screen, based on events which are input from the digitizer 17C in accordance with the movement of a first object (pen 100) on the screen. In other words, a handwritten stroke is displayed on the screen in accordance with the movement of the first object (pen 100) on the screen, which is detected by using the digitizer 17C. Since events, which are input from the touch panel 17B, are not used for the handwriting input process, even if the user's palm or finger comes in contact with the screen, an unintended line is not written. Events, which are input from the touch panel 17B, are used for detecting a gesture operation during a handwriting input operation.

As regards the gesture operation, the handwriting note application program 202 can execute a process corresponding to a gesture operation of a second object (finger) on the screen, based on events which are input from the touch panel 17B in accordance with the movement of the second object (finger) on the screen. In other words, based on events which are input from the touch panel 17B, the handwriting note application program 202 determines which of a plurality of predetermined gesture operations the movement of the second object (finger) on the screen agrees with. Then, the handwriting note application program 202 executes a process corresponding to the agreeing gesture operation.

As has been described above, the pen input mode is such an input mode as to display on the screen a handwritten stroke, based on events which are input from the digitizer 17C in accordance with the movement of the first object (pen 100) on the screen, and as to execute a process corresponding to the gesture operation of the second object (finger) on the screen, based on events which are input from the touch panel 17B in accordance with the movement of the second object (finger) on the screen.

Accordingly, when the touch input mode is in the OFF state (disabled), the user can perform an operation, such as page turn-over, with use of the finger, while inputting characters, graphics, etc. by handwriting with use of the pen 100. Thus, the user can easily view and edit a handwritten document including a plurality of pages.

In the meantime, the touch panel 17B can also detect a contact with the screen by, for example, an electrostatic pen. Thus, the above-described second object may be not only the finger, but also a pen (electrostatic pen) which is different from the pen 100.

FIG. 7 illustrates a handwriting input process in the touch input mode.

When the touch input mode is in an ON state (enabled), that is, when the current input mode is the touch input mode, the handwriting note application program 202 draws a line, which corresponds to the locus of movement of the finger on the screen of the touch-screen display 17, on the screen of the touch-screen display 17. Neither the detection of a finger gesture nor the process corresponding to a detected finger gesture is executed.

To be more specific, when the touch input mode is in the ON state, the handwriting note application program 202 displays on the screen a handwritten stroke in accordance with the movement of the second object (finger) on the screen, which is detected by the touch panel 17B, instead of executing a process corresponding to a gesture operation, based on events which are input from the touch panel 17B. In other words, the handwriting note application program 202 displays on the screen a handwritten stroke, based on events which are input from the touch panel 17B in accordance with the movement of the second object (finger) on the screen. Since input events from the touch panel 17B are used for handwriting input, neither the detection of a finger gesture nor the process corresponding to a detected finger gesture is executed.

In this manner, the touch input mode is such an input mode as to display on the screen a handwritten stroke, based on events which are input from the touch panel 17B in accordance with the movement of the second object (finger) on the screen.

By turning on the touch input mode, the user can perform a handwriting operation by a finger. However, in some cases, the user forgets to disable the touch input mode after the end of use of the handwriting note application program 202 in the state in which the touch input mode is in the ON state. In such cases, the user cannot perform handwriting even if the user executes a handwriting input operation with use of the pen 100. In addition, if the user performs an operation of a swipe gesture by a finger with an intention to perform page turn-over, etc., an unintended line would be drawn on the screen.

Taking this into account, the handwriting note application program 202 of the embodiment includes a function of automatically turning off (disabling) the touch input mode, responding to an input of an event from the digitizer 17C during a period in which the touch input mode is enabled.

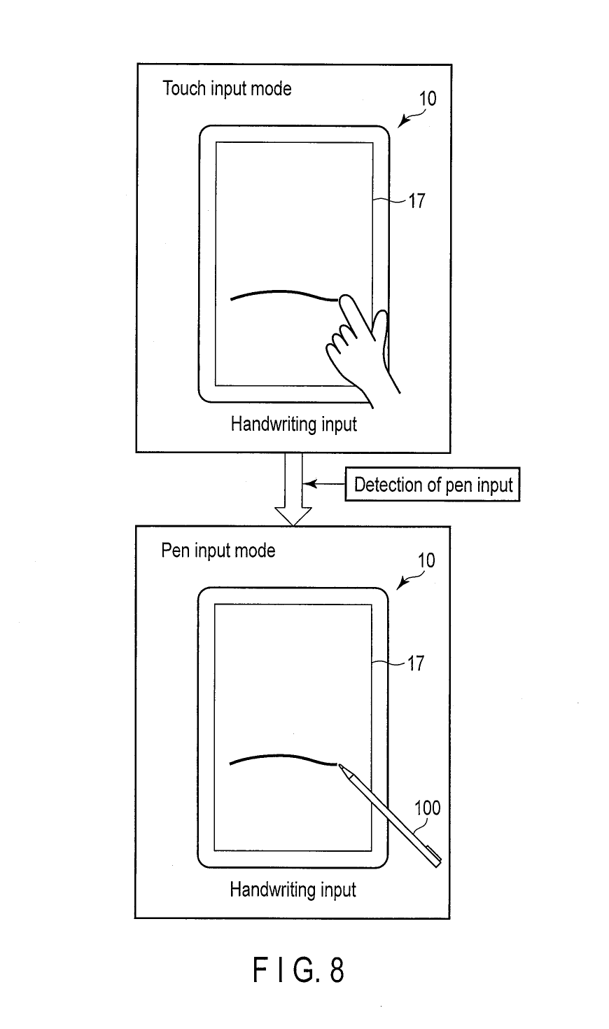

FIG. 8 illustrates an operation of automatically turning off the touch input mode.

Upon receiving an input event from the digitizer 17C during a period in which the touch input mode is enabled, the handwriting note application program 202 automatically turns off the touch input mode.

To be more specific, the handwriting note application program 202 turns off the touch input mode, responding to detection of a contact of the first object (pen 100) with the screen with use of the digitizer 17C during the period in which the input mode is the touch input mode. Thereby, the input mode is switched from the touch input mode to the pen input mode. Subsequently, an input event from the touch panel 17B is used not for handwriting, but for execution of a process corresponding to a finger gesture.

Accordingly, the user can normally start a handwriting input operation with use of the pen 100, without performing an explicit operation for turning off the touch input mode. Thus, even when the user has forgotten to disable the touch input mode, it is possible to prevent the occurrence of such a problem that a handwriting input cannot be performed by the pen 100, or an unintended line is written when a swipe gesture is performed by a finger.

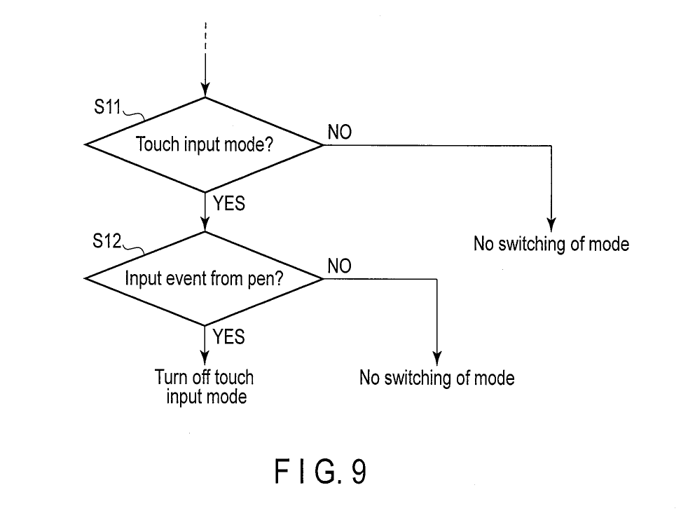

A flowchart of FIG. 9 illustrates the procedure of a touch input mode release process which is executed by the handwriting note application program 202.

When the current input mode is the touch input mode (YES in step S11), the handwriting note application program 202 detects whether an input event from the pen 100 has occurred or not, that is, whether an event from the digitizer 17C has been input in response to a contact of the pen 100 with the screen (step S12). If an event from the digitizer 17C has been input, that is, if reception of an event which is input from the digitizer 17C has been detected (step S12), the handwriting note application program 202 turns off (disables) the touch input mode, thereby switching the input mode from the touch input mode to the pen input mode.

As the event for turning off the touch input mode, use may be made of an event from the digitizer 17C in response to a contact of the pen 100 with an arbitrary location in the screen. Alternatively, in step S12, only an event due to a contact of the pen 100 with the handwriting input area in the screen may be used as the event for turning off the touch input mode.

The user performs handwriting on the handwriting input area in the screen. Thus, the above-described structure, in which only an event due to a contact of the pen 100 with the handwriting input area in the screen is used as the event for turning off the touch input mode, is advantageous in that it is possible to detect the user's intent to perform a handwriting input operation with use of the pen 100.

Next, examples of some typical screens, which are presented to the user by the handwriting note application program 202, will be described.

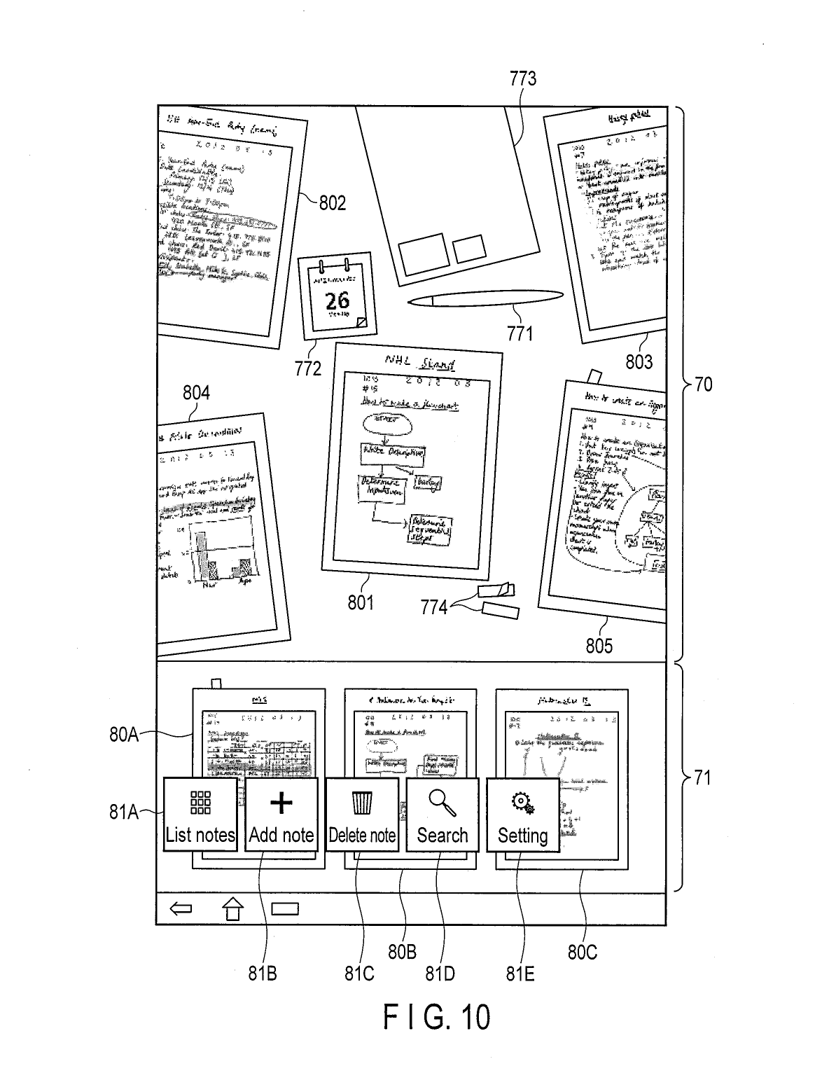

FIG. 10 shows a desktop screen which is displayed by the handwriting note application program 202. The desktop screen is a basic screen for handling a plurality of handwritten document data. In the description below, handwritten document data are referred to as “handwritten notes”.

The desktop screen includes a desktop screen area 70 and a drawer screen area 71. The desktop screen area 70 is a temporary area which displays a plurality of note icons 801 to 805 corresponding to a plurality of handwritten notes on which work is being done. Each of the note icons 801 to 805 displays a thumbnail of a certain page in a corresponding handwritten note. The desktop screen area 70 further displays a pen icon 771, a calendar icon 772, a scrap note (gallery) icon 773, and a tag (label) icon 774.

The pen icon 771 is a graphical user interface (GUI) for switching the display screen from the desktop screen to a page edit screen. The calendar icon 772 is an icon indicative of the present date. The scrap note icon 773 is a GUI for viewing data (referred to as “scrap data” or “gallery data”) which is taken in from another application program or an external file. The tag icon 774 is a GUI for attaching a label (tag) to an arbitrary page in an arbitrary handwritten note.

The drawer screen area 71 is a display area for viewing a storage area for storing all handwritten notes which were created. The drawer screen area 71 displays note icons 80A, 80B and 80C corresponding to some handwritten notes of all handwritten notes. Each of the note icons 80A, 80B and 80C displays a thumbnail of a certain page in a corresponding handwritten note. The handwriting note application program 202 can detect a gesture (e.g. a swipe gesture) on the drawer screen area 71, which is performed by the user with use of a finger. Responding to the detection of this gesture (e.g. a swipe gesture), the handwriting note application program 202 scrolls the screen image on the drawer screen area 71 to the left or to the right. Thereby, note icons corresponding to arbitrary handwritten notes can be displayed on the drawer screen area 71.

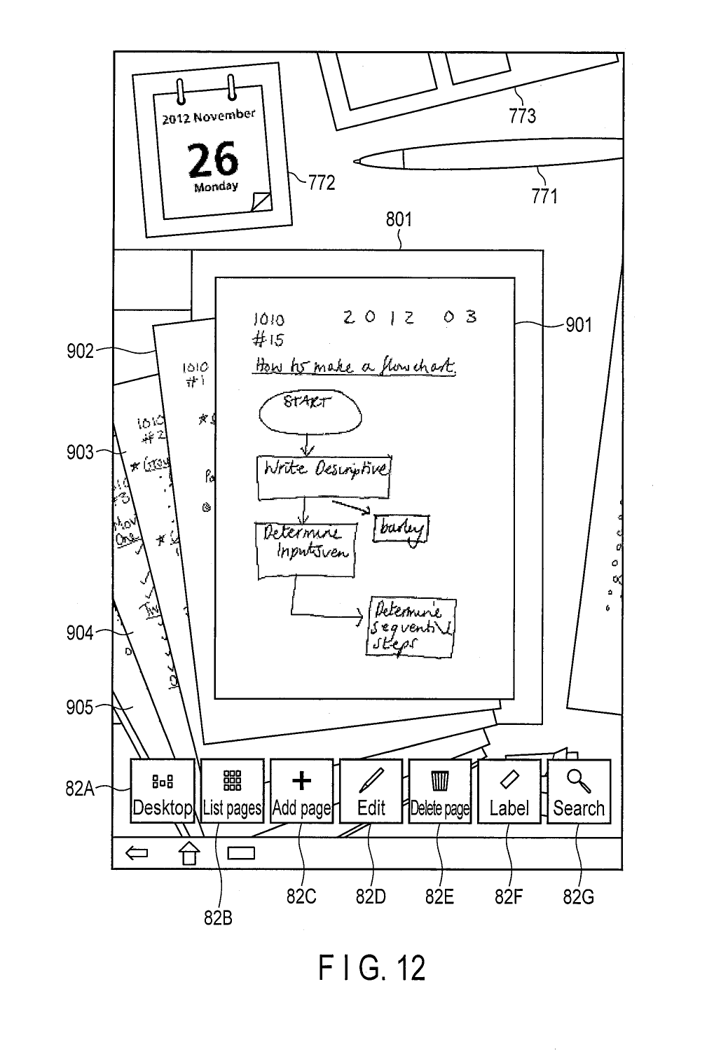

Further, the handwriting note application program 202 can detect a gesture (e.g. a tap gesture) on a note icon of the drawer screen area 71, which is performed by the user with use of the pen 100 or a finger. Responding to the detection of this gesture (e.g. a tap gesture) on a certain note icon on the drawer screen area 71, the handwriting note application program 202 moves this note icon to a central part of the desktop screen area 70. Then, the handwriting note application program 202 selects a handwritten note corresponding to this note icon, and displays a note preview screen shown in FIG. 12, in place of the desktop screen. The note preview screen of FIG. 12 is a screen which enables viewing of an arbitrary page in the selected handwritten note.

Moreover, the handwriting note application program 202 can also detect a gesture (e.g. a tap gesture) on the desktop screen area 70, which is performed by the user with use of the pen 100 or a finger. Responding to the detection of this gesture (e.g. a tap gesture) on a note icon which is located at the central part of the desktop screen area 70, the handwriting note application program 202 selects a handwritten note corresponding to the note icon located at the central part, and displays the note preview screen shown in FIG. 12, in place of the desktop screen.

Besides, the desktop screen can display a menu. This menu includes a list notes button 81A, an add note button 81B, a delete note button 81C, a search button 81D, and a setting button 81E. The list notes button 81A is a button for displaying a list of handwritten notes. The add note button 81B is a button for creating (adding) a new handwritten note. The delete note button 81C is a button for deleting a handwritten note. The search button 81D is a button for opening a search screen (search dialog). The setting button 81E is a button for opening a setup screen.

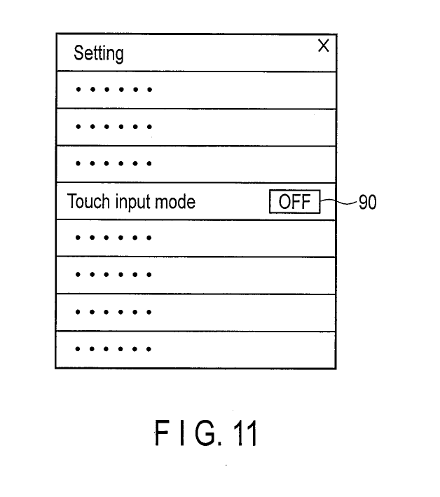

FIG. 11 illustrates a setup screen which is opened when the setting button 81E is tapped by the pen 100 or a finger.

The setup screen displays various setup items. These setup items include a setup item for turning on (enabling) or turning off (disabling) the above-described touch input mode. A default value of the touch input mode is “OFF” (“disabled”). This setup screen including a button 90 corresponding to the touch input mode is a user interface for turning on or off the touch input mode, that is, a user interface for setting the input mode to be the pen input mode (touch input mode=OFF) or the touch input mode. If the button 90 corresponding to the touch input mode is tapped by the pen 100 or a finger, the touch input mode is turned on. If the button 90 is tapped by the pen 100 or a finger in the state in which the touch input mode is already turned on, the touch input mode is turned off.

FIG. 12 illustrates the above-described note preview screen.

The note preview screen is a screen which enables viewing of an arbitrary page in a selected handwritten note. The case is now assumed that a handwritten note corresponding to the note icon 801 has been selected. In this case, the handwriting note application program 202 displays a plurality of pages 901, 902, 903, 904 and 905, which are included in this handwritten note, in such a mode that at least parts of these pages 901, 902, 903, 904 and 905 are visible and that these pages 901, 902, 903, 904 and 905 overlap each other.

The note preview screen further displays the above-described pen icon 771, calendar icon 772, scrap note icon 773, and tag icon 774.

The note preview screen can further display a menu. This menu includes a desktop button 82A, a list pages button 82B, an add page button 82C, an edit button 82D, a delete page button 82E, a label button 82F, and a search button 82G. The desktop button 82A is a button for displaying a desktop screen. The list pages button 82B is a button for displaying a list of pages in a currently selected handwritten note. The add page button 82C is a button for creating (adding) a new page. The edit button 82D is a button for displaying a page edit screen. The delete page button 82E is a button for deleting a page. The label button 82F is a button for displaying a list of kinds of usable labels. The search button 82G is a button for displaying a search screen.

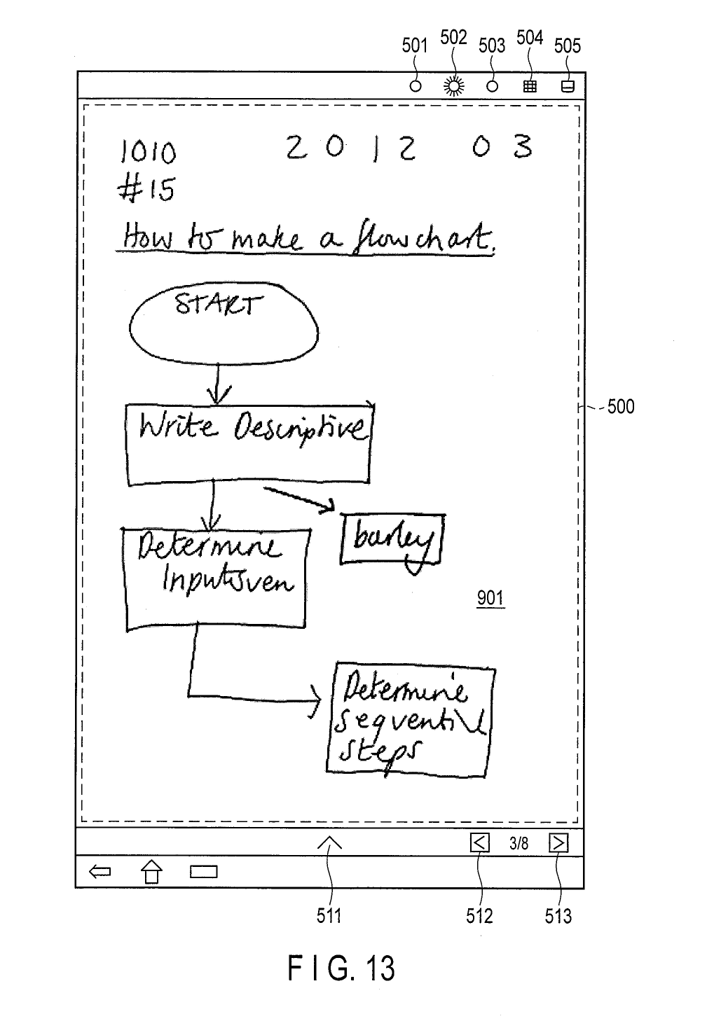

The handwriting note application program 202 can detect various gestures on the note preview screen, which are performed by the user. For example, responding to the detection of a certain gesture, the handwriting note application program 202 changes the page, which is to be displayed uppermost, to an arbitrary page (“page forward”, “page back”). In addition, responding to the detection of a certain gesture (e.g. a tap gesture) which is performed on the uppermost page, or responding to the detection of a certain gesture (e.g. a tap gesture) which is performed on the pen icon 771, or responding to the detection of a certain gesture (e.g. a tap gesture) which is performed on the edit button 82D, the handwriting note application program 202 selects the uppermost page, and displays a page edit screen shown in FIG. 13, in place of the note preview screen.

The page edit screen of FIG. 13 is a screen which enables a handwriting input. This page edit screen is used to create a new page (handwritten page), and to view and edit an existing page. When a page 901 on the note preview screen of FIG. 12 has been selected, the page edit screen displays the content of the page 901, as shown in FIG. 13.

On this page edit screen, a rectangular area 500, which is surrounded by a broken line, is a handwriting input area which enables a handwriting input. The case is now assumed that the touch input mode is in the OFF state.

In the handwriting input area 500, input events from the digitizer 17C are used for display (drawing) of handwritten strokes, and are not used as events indicative of gestures such as a tap. Input events from the touch panel 17B are not used for display (drawing) of handwritten strokes on the handwriting input area 500, but are used as events indicative of gestures such as a tap and a swipe.

On the page edit screen, in an area other than the handwriting input area 500, an input event from the digitizer 17C may be used as an event indicative of a gesture such as a tap.

The page edit screen further displays a quick select menu including three kinds of pens 501 to 503 which are pre-registered by the user, a range select pen 504 and an eraser pen 505. In this example, the case is assumed that a black pen 501, a red pen 502 and a marker 503 are pre-registered by the user. By tapping a certain pen (button) in the quick select menu by the pen 100 or a finger, the user can change the kind of pen that is used. For example, if a handwriting input operation using the pen 100 is executed on the page edit screen in the state in which the black pen 501 is selected by a tap gesture with use of the pen 100 or a finger by the user, the handwriting note application program 202 displays on the page edit screen a black stroke (locus) in accordance with the movement of the pen 100.

The above-described three kinds of pens in the quick select menu can also be switched by an operation of a side button of the pen 100. Combinations of frequently used pen colors and pen thicknesses can be set for the above-described three kinds of pens in the quick select menu.

The page edit screen further displays a menu button 511, a page back button 512, and a page forward button 513. The menu button 511 is a button for displaying a menu.

This menu may include, for example, a button for returning to the note preview screen, a button for adding a new page, and a search button for opening a search screen. This menu may further include a sub-menu for export or import. As the sub-menu for export, use may be made of a menu for prompting the user to select a function of recognizing a handwritten page which is displayed on the page edit screen, and converting the handwritten page to an electronic document file or a presentation file.

Furthermore, the menu may include a button for starting a process of converting a handwritten page to text, and sending the text by e-mail. Besides, the menu may include a button for calling up a pen setup screen which enables a change of the colors (colors of lines to be drawn) and thicknesses (thicknesses of lines to be drawn) of the three kinds of pens in the quick select menu.

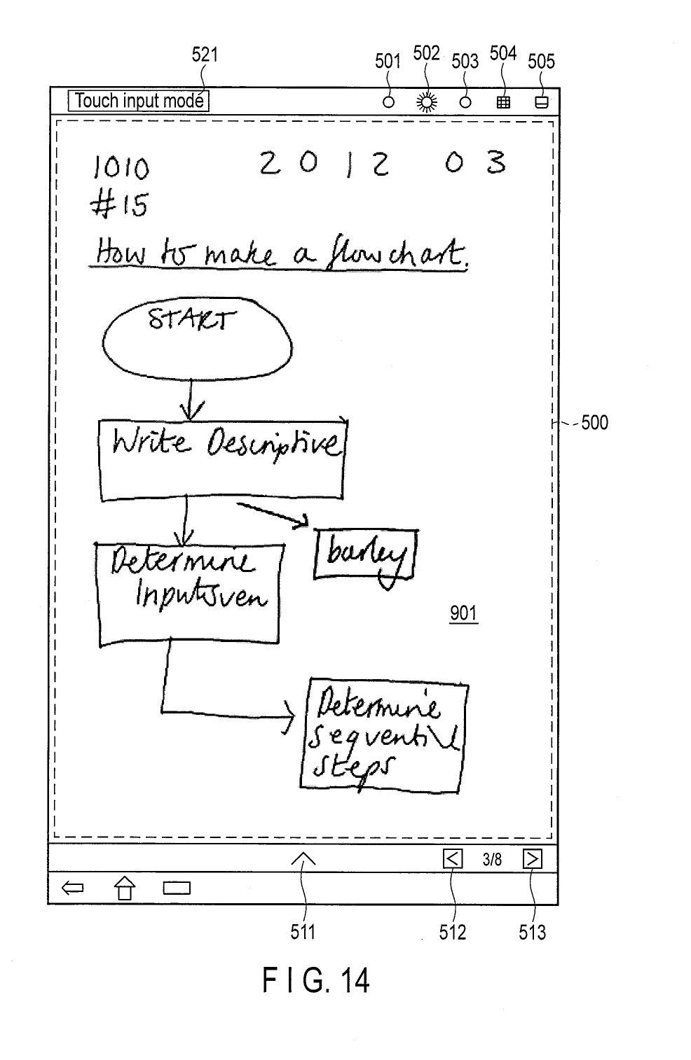

FIG. 14 illustrates a page edit screen corresponding to a case where the touch input mode is turned on.

The page edit screen of FIG. 14 differs from the page edit screen of FIG. 13 in that an indicator 521 including a message, which reads as “Touch input mode”, is displayed on the page edit screen of FIG. 14.

When the touch input mode has been turned on, on the handwriting input area 500, input events from the touch panel 17B are used for display (drawing) of handwritten strokes on the handwriting input area 500, and are not used as events indicative of gestures such as a tap and a swipe. Thus, the user is unable to use finger gestures (left swipe/right swipe) on the handwriting input area 500. However, by tapping the page back button 512 or page forward button 513 by the finger, the user can perform page turn-over.

In addition, the user can also operate the quick select menu or the menu button 511 by the finger.

If the pen 100 is put in contact with the handwriting input area 500 during the period in which the touch input mode is enabled, the handwriting note application program 202 turns off the touch input mode. After the touch input mode is turned off, on the handwriting input area 500, input events from the touch panel 17B are not used for display (drawing) of handwritten strokes on the handwriting input area 500, and are used as events indicative of gestures such as a tap and a swipe. Input events from the digitizer 17C are used for display (drawing) of handwritten strokes.

In this manner, if the user starts handwriting on the handwriting input area 500 with use of the pen 100 when the touch input mode is enabled, the touch input mode is automatically turned off. Specifically, the input mode is automatically restored from the touch input mode to the pen input mode. Thus, the user can perform handwriting on the handwriting input area 500 with use of the pen 100, without performing an operation for turning off the touch input mode, and the user can execute, for example, a page turn-over operation, by performing a finger gesture on the handwriting input area 500.

In the meantime, such a configuration may be adopted that the quick select menu, menu button 511, etc. can be operated by the pen 100, even during the period in which the touch input mode is enabled. In addition, such a configuration may be adopted that the touch input mode is turned off in response to a contact of the pen 100 with the quick select menu, menu button 511, etc.

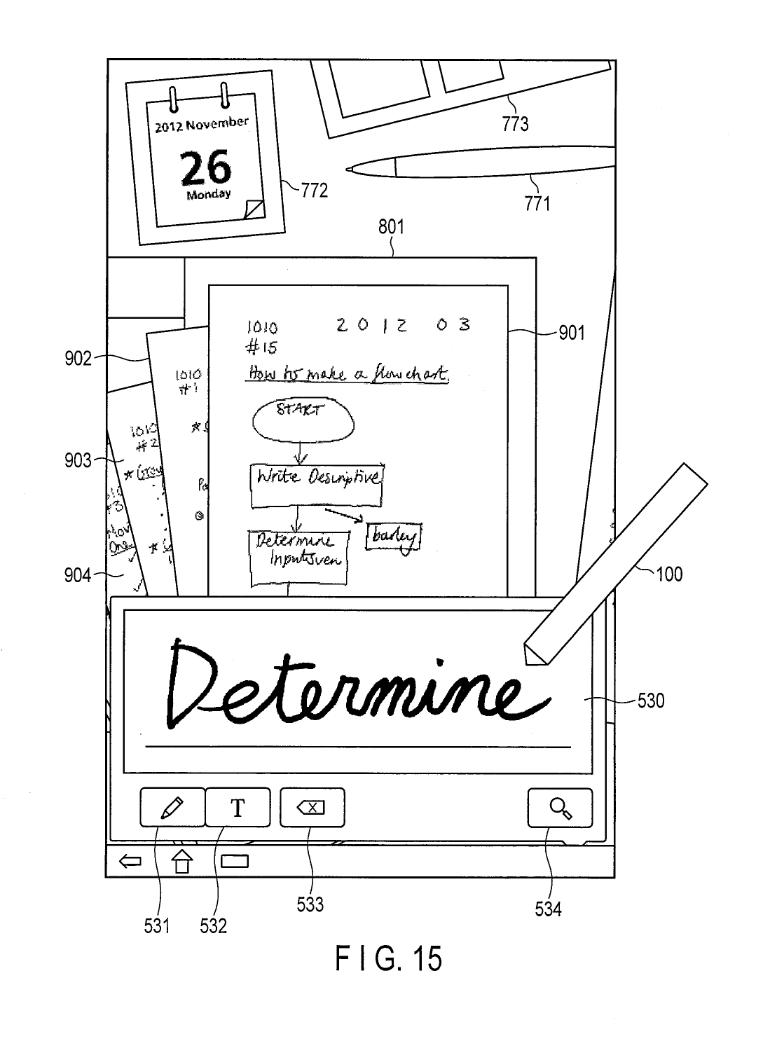

FIG. 15 illustrates an example of the search screen (search dialog). In FIG. 15, the case is assumed that the search screen (search dialog) is opened on the note preview screen.

The search screen displays a search key input area 530, a handwriting search button 531, a text search button 532, a delete button 533 and a search execution button 534. The handwriting search button 531 is a button for selecting a handwriting search. The text search button 532 is a button for selecting a text search. The search execution button 534 is a button for requesting execution of a search process.

In the handwriting search, the search key input area 530 is used as an input area for handwriting a character string, a graphic or a table, which is to be used as a search key. FIG. 15 illustrates, by way of example, a case in which a handwritten character string “Determine” has been input to the search key input area 530 as a search key. The user can handwrite, as well as a handwritten character string, a handwritten graphic or a handwritten table in the search key input area 530 by using the pen 100.

When the touch input mode is in the ON state, the user can also handwrite characters, etc. on the search key input area 530 by the finger. If the user starts handwriting on the search key input area 530 with use of the pen 100 when the touch input mode is enabled, the touch input mode is automatically turned off. Thus, the user can perform handwriting on the search key input area 530 with use of the pen 100, without performing an operation of turning off the touch input mode.

If the search execution button 534 is selected by the user in the state in which the handwritten character string “Determine” has been input to the search key input area 530 as a search key, a handwriting search is executed for searching for a handwritten note including strokes corresponding to strokes (query strokes) of the handwritten character string “Determine”. In the handwriting search, at least one stroke similar to at least one query stroke is searched by matching between strokes. DP (Dynamic Programming) matching may be used in calculating the similarity between plural query strokes and other plural strokes.

In the text search, for example, a software keyboard is displayed on the screen. By operating the software keyboard, the user can input arbitrary text (character string) to the search key input area 530 as a search key. If the search execution button 534 is selected by the user in the state in which the text has been input to the search key input area 530 as a search key, a text search is executed for searching for a handwritten note including stroke data corresponding to this text (query text).

The handwriting search/text search can be executed for a target which is all handwritten notes, or for a target which is only a selected handwritten note. If the handwriting search/text search is executed, a search result screen is displayed. The search result screen displays a list of handwritten pages including strokes corresponding to query strokes (or query text). Hit words (strokes corresponding to query strokes or query text) are displayed with emphasis.

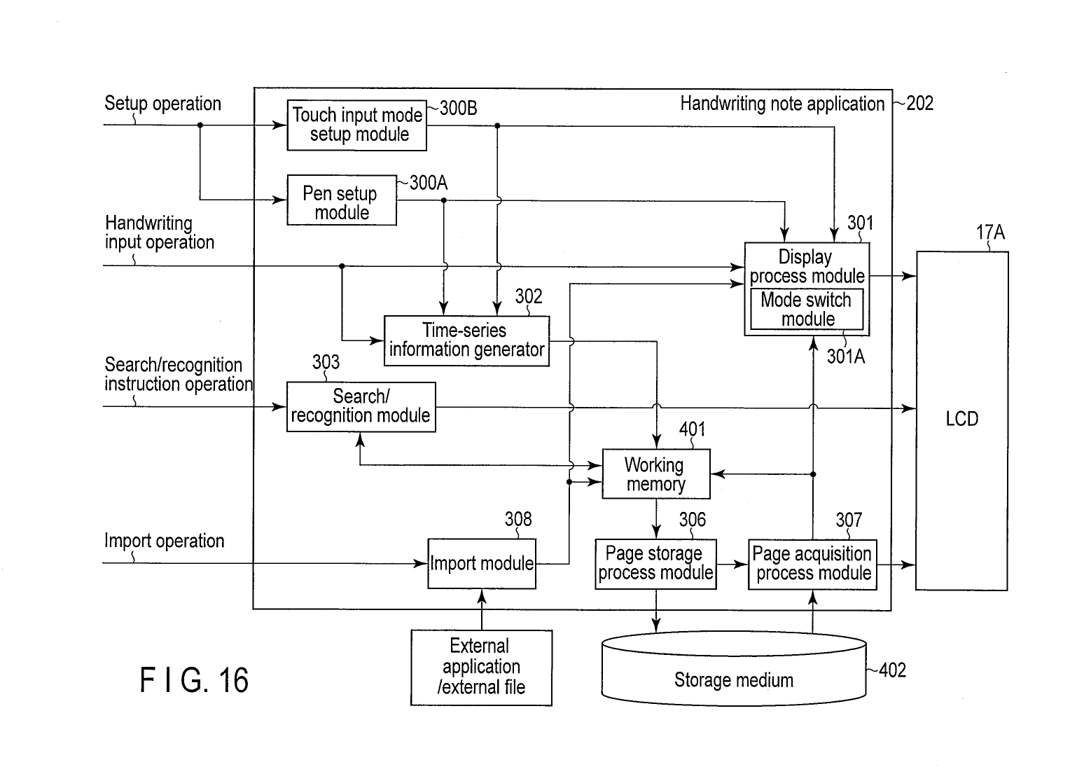

Next, referring to FIG. 16, a description is given of a functional configuration of the handwriting note application program 202.

The handwriting note application program 202 is a WYSIWYG application which can handle handwritten document data. The handwriting note application program 202 includes, for example, a pen setup module 300A, a touch input mode setup module 300B, a display process module 301, a time-series information generator 302, a search/recognition module 303, a page storage process module 306, a page acquisition process module 307, and an import module 308.

The above-described touch panel 17B is configured to detect the occurrence of events such as “touch (contact)”, “move (slide)” and “release”. The “touch (contact)” is an event indicating that an object (finger) has come in contact with the screen. The “move (slide)” is an event indicating that the position of contact of the object (finger) has been moved while the object (finger) is in contact with the screen. The “release” is an event indicating that the object (finger) has been released from the screen.

The above-described digitizer 17C is also configured to detect the occurrence of events such as “touch (contact)”, “move (slide)” and “release”. The “touch (contact)” is an event indicating that an object (pen 100) has come in contact with the screen. The “move (slide)” is an event indicating that the position of contact of the object (pen 100) has been moved while the object (pen 100) is in contact with the screen. The “release” is an event indicating that the object (pen 100) has been released from the screen.

The handwriting note application program 202 displays on the touch-screen display 17 a page edit screen for creating, viewing and editing handwritten page data. The pen setup module 300A displays a user interface (e.g. the above-described plural pen icons, or a menu screen for setting up details of pen styles), and sets up a mode of drawing of strokes in accordance with an operation on the user interface, which is performed by the user.

The touch input mode setup module 300B functions a setup controller configured to display the setup screen which has been described with reference to FIG. 11, and to enable or disable the touch input mode in accordance with an operation on the setup screen, which is performed by the user. In other words, the touch input mode setup module 300B sets the input mode to be the touch input mode or the pen input mode, in accordance with an operation on the setup screen, which is performed by the user.

The display process module 301 and time-series information generator 302 receive an event of “touch (contact)”, “move (slide)” or “release”, which is generated by the digitizer 17C, thereby detecting a handwriting input operation. The “touch (contact)” event includes coordinates of a contact position of the pen 100. The “move (slide)” event includes coordinates of a contact position at a destination of movement of the pen 100. Accordingly, the display process module 301 and time-series information generator 302 can receive coordinate series corresponding to the locus of movement of the contact position from the digitizer 17C.

Similarly, the display process module 301 and time-series information generator 302 can receive an event of “touch (contact)”, “move (slide)” or “release”, which is generated by the touch panel 17B. The “touch (contact)” event includes coordinates of a contact position of the finger. The “move (slide)” event includes coordinates of a contact position at a destination of movement of the finger. Accordingly, the display process module 301 and time-series information generator 302 can receive coordinate series corresponding to the locus of movement of the contact position from the touch panel 17B.

The display process module 301 functions as a processor configured to operate in either the pen input mode (touch input mode=OFF) or the touch input mode (touch input mode=ON).

When the touch input mode is in the OFF state (disabled), or in other words, when the current input mode is a default input mode (pen input mode), the display process module 301 can display a handwritten stroke on the page edit screen, based on events which are input from the digitizer 17C in accordance with the movement of the pen 100 on the page edit screen. Specifically, in the pen input mode, a line, which corresponds to the locus of movement of the pen 100 on the page edit screen, is drawn on the page edit screen. Further, in the pen input mode, the display process module 301 can detect a gesture of the finger on the page edit screen, based on events which are input from the touch panel 17B in accordance with the movement of the finger on the page edit screen. When a gesture of the finger on the page edit screen has been detected, the display process module 301 can execute a process corresponding to the detected gesture.

When the touch input mode is in the ON state (enabled), the display process module 301 can display a handwritten stroke on the page edit screen, based on events which are input from the touch panel 17B, instead of executing a process corresponding to a gesture operation, based on events which are input from the touch panel 17B. Specifically, a line, which corresponds to the locus of movement of the finger on the page edit screen, is drawn on the page edit screen.

Furthermore, the display process module 301 displays on the page edit screen various content data (image data, audio data, text data, and data created by a drawing application) which are imported from an external application/external file by the import module 308.

Besides, the display process module 301 includes a mode switch module 301A. The mode switch module 301A automatically turns off the touch input mode and switches the input mode from the touch input mode to the pen input mode, responding to an input of an event from the digitizer 17C during a period in which the touch input mode is in the ON state. This event from the digitizer 17C is, for example, an event which is input from the digitizer 17C in response to a contact of the pen 100 with the page edit screen (e.g. a contact of the pen 100 with the handwriting input area 500), or an event which is input from the digitizer 17C in response to a contact of the pen 100 with the search key input area 530. Responding to the input of the event, the mode switch module 301A automatically turns off the touch input mode, as described above. If the touch input mode is turned off, the display process module 301 operates in the pen input mode.

When the touch input mode is in the OFF state, the time-series information generator 302 receives the above-described coordinate series (input events) which are output from the digitizer 17C, and generates, based on the coordinate series, handwritten data which includes the time-series information (coordinate data series) having the structure as described in detail with reference to FIG. 4. The time-series information generator 302 temporarily stores the generated handwritten data in a working memory 401. On the other hand, when the touch input mode is in the ON state, the time-series information generator 302 receives the above-described coordinate series (input events) which are output from the touch panel 17B, and generates, based on the coordinate series, handwritten data which includes the time-series information (coordinate data series) having the structure as described in detail with reference to FIG. 4.

The search/recognition module 303 executes a handwriting recognition process of converting a handwritten character string in the handwritten page data to text (character code string), and a character recognition process (OCR) of converting a character string included in an image in the handwritten page data to text (character code string). Further, the search/recognition module 303 can execute the above-described handwriting search and text search.

The page storage process module 306 stores in a storage medium 402 handwritten page data including plural stroke data corresponding to plural handwritten strokes on the handwritten page that is being created. The storage medium 402 may be, for example, the storage device in the tablet computer 10, or the storage device in the server computer 2.

The page acquisition process module 307 acquires arbitrary handwritten page data from the storage medium 402. The acquired handwritten page data is sent to the display process module 301. The display process module 301 displays on the screen a plurality of strokes corresponding to plural stroke data included in the handwritten page data.

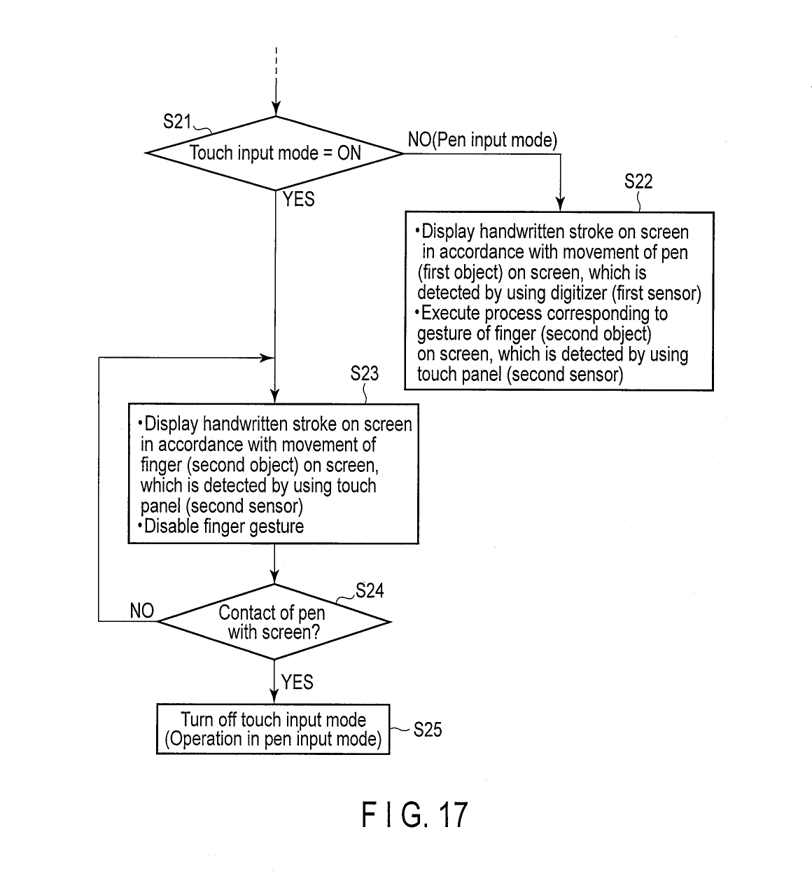

A flowchart of FIG. 17 illustrates the procedure of a handwriting input process which is executed by the handwriting note application program 202.

The handwriting note application program 202 determines whether the touch input mode is in the ON state or in the OFF state (step S21).

If the touch input mode is in the OFF state, that is, if the current handwriting input mode is the pen input mode (NO in step S21), the handwriting note application program 202 advances to step S22.

In step S22, the handwriting note application program 202 displays a handwritten stroke on the screen of the touch-screen display 17 in accordance with the movement of the pen 100 (first object) on the screen of the touch-screen display 17, which is detected by using the digitizer 17C (first sensor). In other words, the handwriting note application program 202 displays a handwritten stroke on the screen, based on events which are input from the digitizer 17C in accordance with the movement of the pen 100 on the screen.

In step S22, furthermore, the handwriting note application program 202 executes a process corresponding to a gesture operation of the finger (second object) on the screen, which is detected by using the touch panel 17B (second sensor). In other words, the handwriting note application program 202 executes a process corresponding to a gesture operation of the finger on the screen, based on events which are input from the touch panel 17B in accordance with the movement of the finger on the screen.

In this manner, in the pen input mode, events which are input from the touch panel 17B are used for executing a process corresponding to a finger gesture.

If the touch input mode is in the ON state, that is, if the current handwriting input mode is the touch input mode (YES in step S21), the handwriting note application program 202 advances to step S23.

In step S23, the handwriting note application program 202 uses the events, which are input from the touch panel 17B, not for executing a process corresponding to a finger gesture, but for handwriting input. Specifically, the handwriting note application program 202 displays a handwritten stroke on the screen of the touch-screen display 17 in accordance with the movement of the finger (second object) on the screen of the touch-screen display 17, which is detected by using the touch panel 17B (second sensor). In other words, the handwriting note application program 202 displays on the screen a handwritten stroke, based on events which are input from the touch panel 17B in accordance with the movement of the finger on the screen. Thereby, a line, which corresponds to the locus of movement of the finger on the screen, is drawn on the screen of the touch-screen display 17. Neither the detection of a finger gesture nor the process corresponding to a detected finger gesture is executed.

In this manner, the events, which are input from the touch panel 17B, are used not for executing a process corresponding to a finger gesture, but for handwriting input, that is, display of a handwritten stroke.

While the touch input mode is in the ON state, the handwriting note application program 202 detects whether the pen 100 has come in contact with the screen of the touch-screen display 17, that is, whether an event from the digitizer 17C is input or not (step S24). If an input of an event from the digitizer 17C has been detected (YES in step S24), the handwriting note application program 202 turns off the touch input mode, thereby switching the input mode from the touch input mode to the pen input mode (step S25). Subsequently, input events from the touch panel 17B are used not for handwriting input, but for execution of a process corresponding to a finger gesture. The handwriting note application program 202 displays a handwritten stroke on the screen, based on events which are input from the digitizer 17C.

As has been described above, in the present embodiment, when the touch input mode is in the OFF state, that is, when the current handwriting input mode is the pen input mode, a handwritten stroke can be displayed on the screen, based on events which are input from the first sensor (digitizer 17C) in accordance with the movement of the first object (pen 100) on the screen, and a process corresponding to a gesture operation can be executed, based on events which are input from the second sensor (touch panel 17B) in accordance with the movement of the second object (finger) on the screen. On the other hand, when the touch input mode is in the ON state, that is, when the input mode is the touch input mode, events, which are input from the second sensor (touch panel 17B), may be used not for executing a process corresponding to a gesture operation, but for displaying handwritten strokes on the screen. Thus, by turning on the touch input mode, the user can execute a handwriting input by the second object (finger).

Furthermore, responding to an input of an event from the digitizer 17C (first sensor) during the period in which the input mode is the touch input mode, the touch input mode is automatically turned off. Accordingly, even without performing an explicit operation for turning off the touch input mode, the user can execute a handwriting input with use of the pen 100 by simply putting the pen 100 in contact with the screen, that is, by simply starting a handwriting input operation with use of the pen 100. Thus, even when the user has forgotten to disable the touch input mode, it is possible to prevent the occurrence of such a problem that a handwriting input cannot be performed by the pen 100, or an unintended line is written when a swipe gesture is performed by a finger. In this manner, a handwriting input can easily be executed by providing the scheme which dynamically changes an operation which is to be executed in accordance with events which are input from the second sensor (touch panel 17B), and dynamically disables the touch input mode while the touch input mode is being used.

In the meantime, the touch panel 17B can also detect a contact with the screen by an electrostatic pen. Thus, the user can use the electrostatic pen which is different from the pen 100, instead of the finger.

Since the various processes of the embodiment can be realized by a computer program, the same advantageous effects as with the present embodiment can easily be obtained simply by installing the computer program into an ordinary computer through a computer-readable storage medium which stores the computer program, and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a processor configured to display, if an input mode is a first mode, a handwritten stroke on a screen, based on an event which is input from a first sensor in accordance with a movement of a first object on the screen, and to execute a first process corresponding to a gesture operation of a second object on the screen, based on an event which is input from a second sensor in accordance with a movement of the second object on the screen, wherein the processor is configured to display, if the input mode is a second mode, a handwritten stroke on the screen, based on an event which is input from the second sensor in accordance with a movement of the second object on the screen, the second object different from the first object, the second sensor different from the first sensor; and
a setup controller configured to set the input mode to be the first mode or the second mode in accordance with an operation of a user,
wherein the processor is further configured to switch the input mode from the second mode to the first mode, in response to an input of a first event from the first sensor during a period in which the input mode is the second mode.

2. The electronic device of claim 1, wherein the first event includes an event which is input from the first sensor in response to a contact of the first object with a handwriting input area in the screen.

3. The electronic device of claim 1, wherein the first process includes a process of turning over a handwritten page on the screen.

4. The electronic device of claim 1, further comprising a search controller configured to search for, with use of a first handwritten stroke which is input to a search key input area on a search screen as a search key, a handwritten document including a second handwritten stroke which corresponds to the first handwritten stroke,
wherein the first event includes an event which is input from the first sensor in response to a contact of the first object with the search key input area.

5. The electronic device of claim 1, wherein the processor is configured to display a page turn-over button on the screen, and to execute a process of turning over a handwritten page on the screen, when the processor has received, during the period in which the input mode is the second mode, an event which is input from the second sensor in response to a contact of the second object with the page turn-over button.

6. The electronic device of claim 1, wherein the first object is a pen, and the second object is a finger.

7. The electronic device of claim 1, wherein the first sensor is a digitizer.

8. The electronic device of claim 1, wherein the second sensor is a touch panel.

9. A method comprising:
setting an input mode to be a first mode or a second mode in accordance with an operation of a user;
displaying, if the input mode is the first mode, a handwritten stroke on a screen, based on an event which is input from a first sensor in accordance with a movement of a first object on the screen, and executing a first process corresponding to a gesture operation of a second object on the screen, based on an event which is input from a second sensor in accordance with a movement of the second object on the screen, the second object different from the first object, the second sensor different from the first sensor;
displaying, if the input mode is the second mode, a handwritten stroke on the screen, based on an event which is input from the second sensor in accordance with a movement of the second object on the screen; and
switching the input mode from the second mode to the first mode, in response to an input of a first event from the first sensor during a period in which the input mode is the second mode.

10. The method of claim 9, wherein the first event includes an event which is input from the first sensor in response to a contact of the first object with a handwriting input area in the screen.

11. The method of claim 9, wherein the first process includes a process of turning over a handwritten page on the screen.

12. The method of claim 9, further comprising searching for, with use of a first handwritten stroke which is input to a search key input area on a search screen as a search key, a handwritten document including a second handwritten stroke which corresponds to the first handwritten stroke,
wherein the first event includes an event which is input from the first sensor in response to a contact of the first object with the search key input area.

13. A computer-readable, non-transitory storage medium having stored thereon a computer program which is executable by a computer, the computer program controlling the computer to execute functions of:
setting an input mode to be a first mode or a second mode in accordance with an operation of a user;
displaying, if the input mode is the first mode, a handwritten stroke on a screen, based on an event which is input from a first sensor in accordance with a movement of a first object on the screen, and executing a first process corresponding to a gesture operation of a second object on the screen, based on an event which is input from a second sensor in accordance with a movement of the second object on the screen, the second object different from the first object, the second sensor different from the first sensor;
displaying, if the input mode is the second mode, a handwritten stroke on the screen, based on an event which is input from the second sensor in accordance with a movement of the second object on the screen; and
switching the input mode from the second mode to the first mode, in response to an input of a first event from the first sensor during a period in which the input mode is the second mode.

14. The storage medium of claim 13, wherein the first event includes an event which is input from the first sensor in response to a contact of the first object with a handwriting input area in the screen.

15. The storage medium of claim 13, wherein the first process includes a process of turning over a handwritten page on the screen.

16. The storage medium of claim 13, wherein the computer program further controls the computer to execute a function of searching for, with use of a first handwritten stroke which is input to a search key input area on a search screen as a search key, a handwritten document including a second handwritten stroke which corresponds to the first handwritten stroke, and
the first event includes an event which is input from the first sensor in response to a contact of the first object with the search key input area.
